(19) United States
(12) Patent Application Publication
(10) Pub. No.: US 2017/0372659 A1
(43) Pub. Date: Dec. 28, 2017

(54) REDUCING BURN-IN OF DISPLAYED IMAGES

(71) Applicant: Anki, Inc., San Francisco, CA (US)

(72) Inventors: Nathaniel D. Monson, Sunnyvale, CA (US); Andrew Neil Stein, San Francisco, CA (US); Daniel Thomas Casner, Livermore, CA (US)

(21) Appl. No.: 15/631,495

(22) Filed: Jun. 23, 2017

Related U.S. Application Data
(60) Provisional application No. 62/354,652, filed on Jun. 24, 2016.

(51) Int. Cl. G09G 3/3233; G02F 1/1337; G09G 3/20; H05B 33/08

(52) U.S. Cl. CPC G09G 3/3233; H05B 33/0896; G02F 1/133707; G09G 3/2014; G09G 3/2022

(57) ABSTRACT

Exemplary methods, apparatuses, and systems generate an object in a portion of an electronic display. The object is generated as a shape formed by a pattern of a first plurality of pixels being illuminated for a first sequence of frames and a second plurality of pixels not being illuminated for the first sequence of frames. During the first sequence of frames, each set of illuminated pixels from the first plurality of pixels is separated from another set of illuminated pixels by a set of non-illuminated pixels of the second plurality of pixels. In response to an event, the object in the portion of the electronic display is generated by illuminating pixels of the second plurality of pixels for a second sequence of frames and not illuminating pixels within the first plurality of pixels for the second sequence of frames.

### CROSS-REFERENCE TO RELATED APPLICATIONS

This application claims the benefit of U.S. Provisional Application No. 62/354,652 filed Jun. 24, 2016, which is hereby incorporated by reference.

### FIELD OF THE INVENTION

The various embodiments described in this document relate to electronic displays. In particular, embodiments relate to preventing display degradation due to screen or image burn-in.

### BACKGROUND OF THE INVENTION

Many types of electronic displays are susceptible to screen burn-in, wherein certain areas of the screen become permanently discolored because of cumulative non-uniform usage of pixels. For example, prolonged display of an object in the same location can create a permanent ghost-like image of the object (even when the object isn't displayed) or otherwise degrade image quality. Extended activation of pixels may cause loss of luminance. Accordingly, if pixel use is non-uniform, some pixels may lose more luminance than others, causing discoloration of some areas of the screen. Extended display of a monochrome image may exacerbate the problem.

### BRIEF DESCRIPTION OF THE DRAWINGS

The present embodiments are illustrated by way of example and not limitation in the figures of the accompanying drawings, in which like references indicate similar elements, and in which:

FIGS. 1-6 illustrate an exemplary sequence of frames, including a display object, that swap illuminated sets of pixels and non-illuminated sets of pixels to reduce screen burn-in;

FIG. 7 illustrates, in block diagram form, components of a system that swaps illuminated sets of pixels and non-illuminated sets of pixels to reduce screen burn-in; and

FIG. 8 is a flow chart illustrating an exemplary method of swapping illuminated sets of pixels and non-illuminated sets of pixels to reduce screen burn-in.

### DETAILED DESCRIPTION

This document describes embodiments that relate to preventing or otherwise reducing screen burn-in. Embodiments generate an object in a portion of an electronic display. Generating the object includes forming the shape using a pattern of illuminated and non-illuminated pixels. Each set of illuminated pixels is separated from another set of illuminated pixels by a set of non-illuminated pixels. In other words, the object appears as a shape formed by shading or fill of alternating illuminated and non-illuminated sets of pixels. In response to a swap event, embodiments generate the object in the portion of the electronic display by swapping illuminated and non-illuminated sets of pixels. For example, in response to a change in shape of the object, embodiments illuminate pixels within the sets that were previously non-illuminated and do not illuminate pixels within the sets that were previously illuminated. As a result, no particular pixel remains activated for too long, thus limiting or avoiding burn-in.

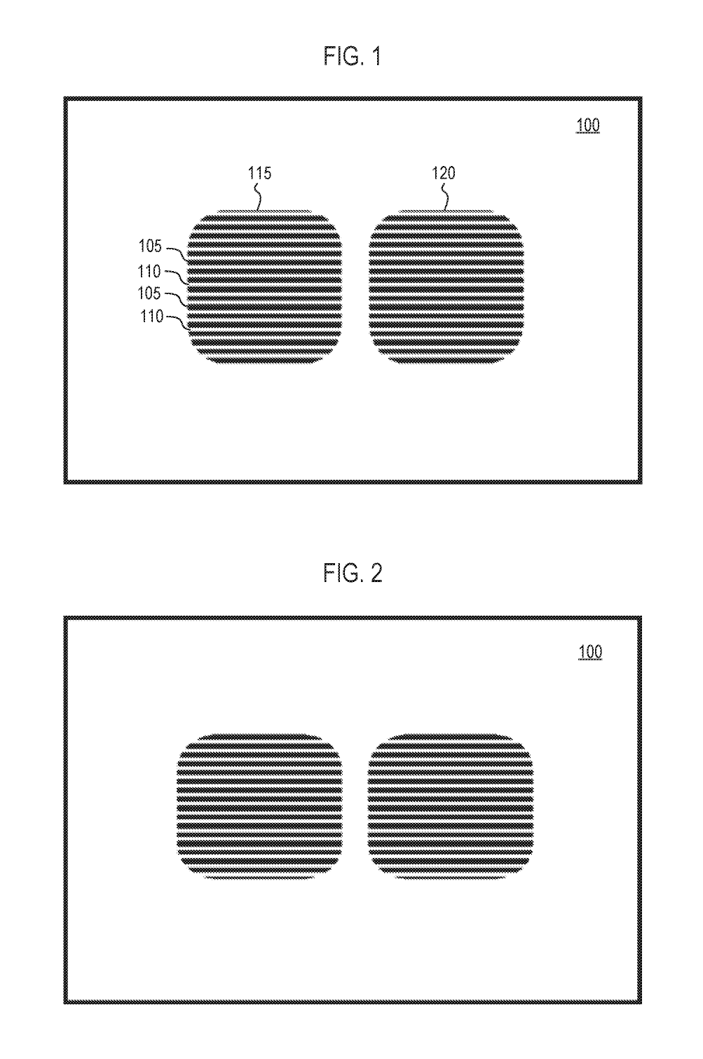

FIGS. 1-6 illustrate an exemplary sequence of frames, including a display object, that swap illuminated sets of pixels and non-illuminated sets of pixels to reduce screen burn-in. In particular, the exemplary sequence of frames is an animation including display objects representing two stylized eyes on electronic display 100. Each frame displays sets of alternating illuminated horizontal lines and non-illuminated horizontal lines to form right eye 115 and left eye 120. Embodiments swap the on/off pattern of illuminated and non-illuminated lines, so that no single pixel is illuminated for the entire sequence.

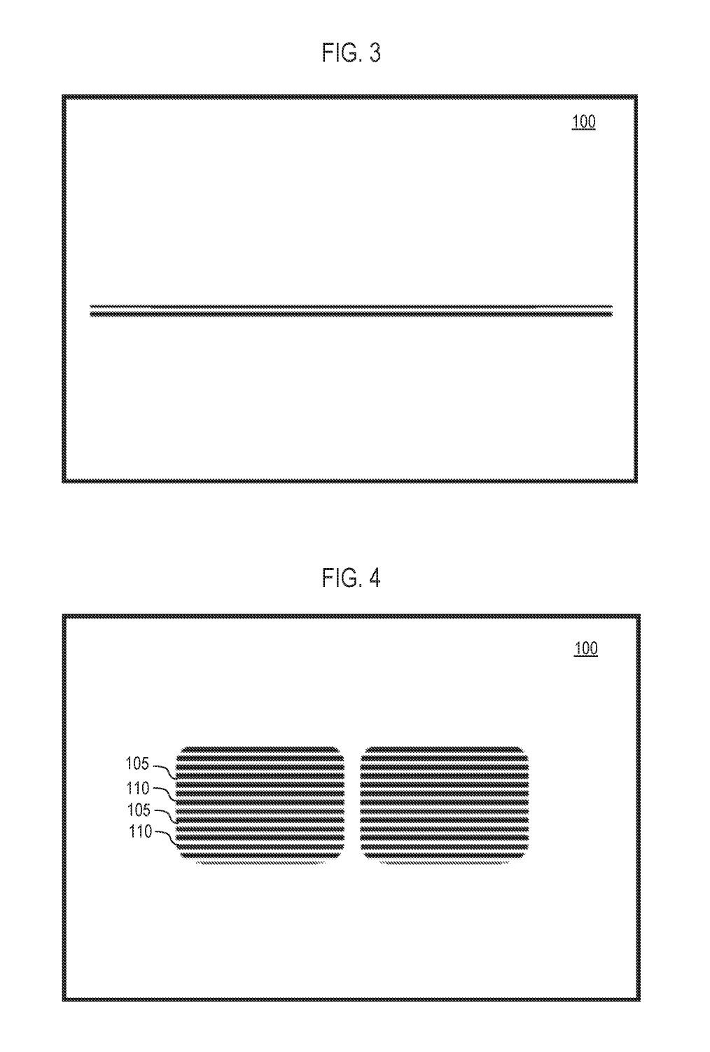

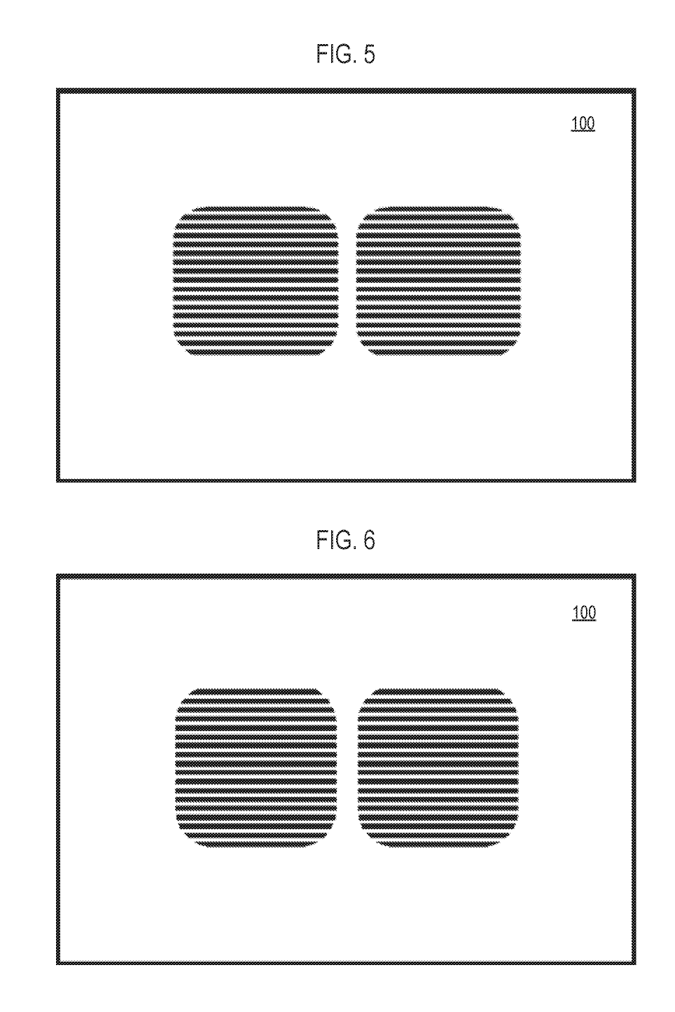

In this illustrated sequence of frames, the swap takes place simultaneously with a blink effect, as shown in FIG. 3, so that the swap is less noticeable to a viewer. For example, FIG. 1 illustrates two sets of illuminated lines 105 alternating with non-illuminated lines 110 to form right eye 115 and left eye 120, depicting two eyes in a wide-open state to the viewer. FIG. 2 illustrates a change in shape of the display objects by altering the number and/or length of the illuminated lines (or otherwise changing the number and/or size of the sets of illuminated pixels). This change in shape of the display objects presents to the viewer the pair of eyes as narrowing or otherwise beginning to close. FIG. 3 illustrates further change in shape of the display objects by altering the number and/or length of the illuminated lines. This change in shape of the display objects presents to the viewer the pair of eyes as closed mid-blink. FIG. 4 illustrates further change in shape of the display objects by altering the number and/or length of the illuminated lines. This change in shape of the display objects presents to the viewer the pair of eyes as opening following the blink. Embodiments execute the swap of illuminated and non-illuminated lines simultaneously with or otherwise in response to the blink. For example, electronic display 100 in FIG. 4 illustrates horizontal lines 105, which were illuminated in FIGS. 1-2, as no longer being illuminated and horizontal lines 110, which were not illuminated in FIGS. 1-2, as now illuminated. The swap of illuminated and non-illuminated lines persists through the further changing in shape of the display objects by altering the number and/or length of the illuminated lines in FIGS. 5-6. This change in shape of the display objects presents to the viewer the pair of eyes as opening further following the blink and returning to a wide-open state.

In summary, in FIGS. 1-2 (pre-blink), embodiments illuminate a first set of horizontal lines and in FIGS. 4-6 (post-blink), embodiments illuminate an opposite set of horizontal lines. As a result, the wide-open eyes generated on a portion of electronic display 100 as shown in FIG. 1 are illustrated with the opposite set of lines in that portion of electronic display as shown FIG. 6. This swap prevents prolonged activation of a set of pixels, reducing the likelihood of screen burn-in, while maintaining the display of objects in that portion of electronic display 100. The intermediate sequence of frames temporarily changing the shape of the objects provides a way for the swap to occur in a less noticeable manner. It would be difficult for a viewer to perceive the swap of illuminated and non-illuminated sets of pixels when the swap is performed during such a change in shape of the display object(s). The blink effect is just one example of mechanisms that can hide or minimize noticeability of the swapping of illuminating and non-illuminated lines. In other embodiments, the swap may be performed gradually (e.g., one pair of illuminated and non-illuminated sets swapped at a time), or it can be performed without an attempt to hide it.

While FIGS. 1-6 illustrate an animation of blinking eyes in a sequence of six frames, other embodiments may include another number of intermediate frames to display the various stages of change in shape of each eye as the eyes close or open. For example, additional frames in the animation sequence may include the eyes in intermediate shapes between those depicted.

While FIGS. 1-6 illustrate display objects formed by parallel horizontal lines, other arrangements are possible. For example, vertical lines or lines of any orientation can be used instead of horizontal lines. The sets of pixels may form shapes as well, such as squares, concentric circles, etc.

Swapping on/off patterns of illumination may take place according to any suitable periodic arrangement or may be triggered by scene changes or any other suitable events. For example, an author, artist, animator, or other individual may manually encode a swap event during the display and/or changing display of one or more objects. Alternatively, embodiments may automatically trigger a swap event based on display content.

In an embodiment including the manual approach, an individual embeds a swap command in the display content stream or otherwise in the parameters used to draw objects on the display. When the swap command is encountered, the software used to draw the object performs the swap. The author, artist, animator, or other individual can choose to insert the swap command at particular times in the display of one or more objects when he or she feels a swap will be least noticeable by a viewer. For example, as described in this document, the animation of a blinking eye may include a swap command when/once the eye is closed.

In an embodiment including the automated approach, software automatically analyzes the content stream or animation to determine if particular frames meet certain criteria for being a suitable time for a swap. For example, if a set of one or more frames include a blank screen, or if a frame closely matches a design predetermined to be appropriate for a swap (such as a blink as depicted in FIG. 3), then the swap can be automatically triggered in response to or otherwise at the time that frame is displayed. The automated approach thus avoids the need for the author, artist, animator, or other individual to specify swap times or even to be aware of screen burn-in or pattern swapping.

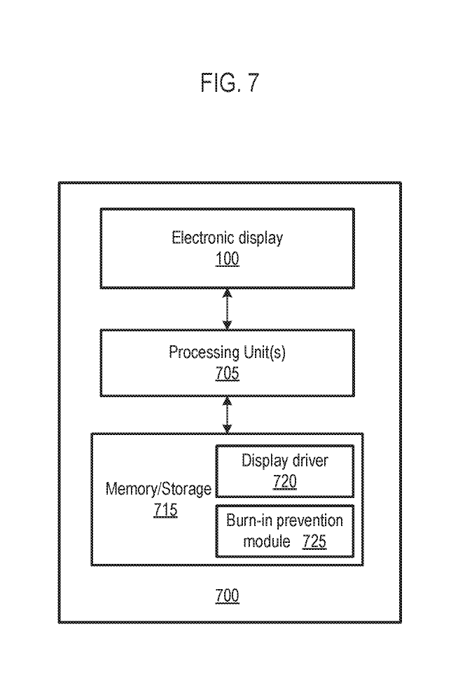

FIG. 7 illustrates, in block diagram form, components of system 700 that swaps illuminated sets of pixels and non-illuminated sets of pixels to reduce screen burn-in. For example, system 700 may include a computer, mobile device, and/or other consumer electronics device that has the components described in this document.

System 700 includes one or more processing units 705. Processing unit(s) 705 may include a central processing unit (CPU), graphics processing unit (GPU), microprocessor, microcontroller, system on a chip, and/or another integrated circuit.

System 700 also includes electronic display 100 coupled to processing unit(s) 705. For example, electronic display 100 may be a liquid crystal display (LCD), light emitting diode (LED) display, organic LED (OLED) display, plasma display panel (PDP) or other type of display. In one embodiment, electronic display 100 is monochromatic.

System 700 also includes memory/storage 715. Memory/storage 715 may include one or more of volatile and non-volatile memories, such as Random Access Memory (RAM), Read Only Memory (ROM), a solid-state disk (SSD), Flash, Phase Change Memory (PCM), or other types of data storage. Memory/storage 715 may store data, metadata, and/or programs for execution by the processing unit(s) 705. For example, memory/storage 715 stores program module(s) such as display driver 720 and burn-in prevention module 725.

In one embodiment, display driver 720 is a computer program that provides an interface for and controls output to electronic display 100. Display driver 720 enables an operating system or other computer program to access the functionality of electronic display 100. Alternatively, or additionally, processing unit(s) 705 provide a hardware interface to electronic display 100.

In one embodiment, burn-in prevention module is a computer program that executes a swap command or automatically triggers a swap event based on display content. Examples of manual and automatic swap events are described with reference to the other drawings.

While this document illustrates and describes embodiments implemented using software modules, alternate embodiments of the invention may be implemented in, but not limited to, hardware or firmware utilizing an FPGA, ASIC, and/or processing unit(s) 705. Modules and apparatus of hardware or software implementations can be divided or combined without significantly altering embodiments of the invention. One or more buses interconnect components of system 700. Fewer or more buses than illustrated may interconnect the components. In one embodiment, one or more components may connect to one another wirelessly.

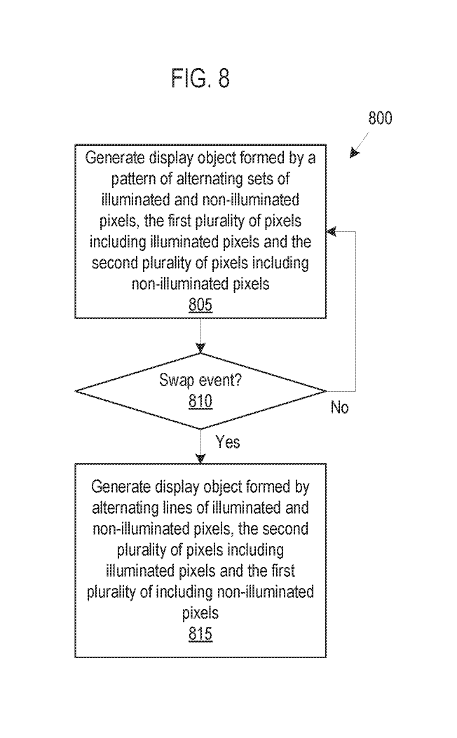

FIG. 8 is a flow chart illustrating exemplary method 800 of swapping illuminated sets of pixels and non-illuminated sets of pixels to reduce screen burn-in. At block 805, processing unit(s) 705 generate one or more display objects on electronic display 100. Processing unit(s) 705 generate the display object(s) by instructing electronic display 100 to display alternating sets of illuminated and non-illuminated pixels. Each set of illuminated pixels is separated by a set of pixels that are not illuminated. Right eye 115 and left eye 120 are examples of such display objects.

At block 810, processing unit(s) 705 determine whether a swap event has occurred. For example, processing unit(s) 705 detect a swap event in response to receiving a manual swap command. Alternatively, burn-in prevention module 725 automatically triggers a swap event in response to a change in shape of the object(s) as described above.

If processing unit(s) 705 determine a swap event has not occurred, method 800 returns to block 805 to continue generation of the display object(s). The continued generation of the display object(s) may include, for example, a change in the shape of the object(s). For example, FIGS. 1-2 illustrate continued generation of display objects that include a change in size of the objects but without triggering a swap event.

If processing unit(s) 705 determine a swap event has occurred, at block 815, processing unit(s) generate the display object(s) formed by alternating sets of illuminated and non-illuminated pixels, such that one or more sets of pixels that were previously illuminated are now not illuminated and one or more sets of pixels that were previously not illuminated are now illuminated.

It will be apparent from this description that aspects of the inventions may be embodied, at least in part, in software. That is, computer-implemented method 800 may be carried out in one or more computer systems or other data processing systems, such as system 700, in response to its processor executing sequences of instructions contained in a memory or another non-transitory machine-readable storage medium. The software may further be transmitted or received over a wired or wireless connection via a network interface. In various embodiments, hardwired circuitry may be used in combination with the software instructions to implement the present embodiments. Thus, the techniques are not limited to any specific combination of hardware circuitry and software, or to any particular source for the instructions executed by a node and/or central controller. It will also be appreciated that additional components, not shown, may also be part of system 700, and, in certain embodiments, fewer components than that shown in FIG. 7 may also be used in system 700.

In the foregoing specification, the invention(s) have been described with reference to specific exemplary embodiments thereof. Various embodiments and aspects of the invention(s) are described with reference to details discussed in this document, and the accompanying drawings illustrate the various embodiments. The description above and drawings are illustrative of the invention and are not to be construed as limiting the invention. References in the specification to “one embodiment,” “an embodiment,” “an exemplary embodiment,” etc., indicate that the embodiment described may include a particular feature, structure, or characteristic, but not every embodiment may necessarily include the particular feature, structure, or characteristic. Moreover, such phrases are not necessarily referring to the same embodiment. Furthermore, when a particular feature, structure, or characteristic is described in connection with an embodiment, such feature, structure, or characteristic may be implemented in connection with other embodiments whether or not explicitly described. Additionally, as used in this document, the term “exemplary” refers to embodiments that serve as simply an example or illustration. The use of exemplary should not be construed as an indication of preferred examples. Blocks with dashed borders (e.g., large dashes, small dashes, dot-dash, dots) are used to illustrate virtualized resources or, in flow charts, optional operations that add additional features to embodiments of the invention. However, such notation should not be taken to mean that these are the only options or optional operations, and/or that blocks with solid borders are not optional in certain embodiments of the invention. Numerous specific details are described to provide a thorough understanding of various embodiments of the present invention. However, in certain instances, well-known or conventional details are not described in order to provide a concise discussion of embodiments of the present inventions.

Embodiments according to the invention are, in particular, disclosed in the claims directed to a method, a storage medium, and a system, wherein any feature mentioned in one claim category, e.g., the system, can be claimed in another claim category, e.g., the method, as well. The dependencies or references in the claims are chosen for formal reasons only. Any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

It will be evident that various modifications may be made thereto without departing from the broader spirit and scope of the invention as set forth in the following claims. For example, the methods described in this document may be performed with fewer or more features/blocks or the features/blocks may be performed in differing orders. Additionally, the methods described in this document may be repeated or performed in parallel with one another or in parallel with different instances of the same or similar methods.

What is claimed is:

1. A computer-implemented method comprising:
generating an object in a portion of an electronic display, the object generated as a shape formed by a pattern of a first plurality pixels being illuminated for a first sequence of frames and a second plurality of pixels not being illuminated for the first sequence of frames, the first plurality of pixels including sets of one or more illuminated pixels, each set of one or more illuminated pixels separated from another set of illuminated pixels by a set of non-illuminated pixels of the second plurality of pixels; and
generating, in response to an event, the object in the portion of the electronic display by illuminating pixels of the second plurality of pixels for a second sequence of frames, each set of illuminated pixels of the second plurality of pixels separated from another set of illuminated pixels within the second plurality of pixels by a set of non-illuminated pixels of the first plurality of pixels.

2. The computer-implemented method of claim 1, the method further comprising:
generating, as a third sequence of frames, a change in shape of the object by altering a number or size of the sets of the first plurality of pixels, wherein the event is the change in shape of the object.

3. The computer-implemented method of claim 2, wherein the object represents an eye.

4. The computer-implemented method of claim 3, wherein the change in shape represents a blink of the eye.

5. The computer-implemented method of claim 1, wherein the event is a temporary removal of the shape from the electronic display.

6. The computer-implemented method of claim 1, wherein the event is a display command to swap illumination between the first and second pluralities of pixels.

7. The computer-implemented method of claim 1, wherein pixels illuminated on the electronic display are monochromatic.

8. The computer-implemented method of claim 1, wherein the sets of illuminated pixels in the first plurality of pixels form parallel horizontal lines.

9. A non-transitory computer-readable medium storing instructions, which when executed by a processing device, cause the processing device to perform a method comprising:
generating an object in a portion of an electronic display, the object generated as a shape formed by a pattern of a first plurality pixels being illuminated for a first sequence of frames and a second plurality of pixels not being illuminated for the first sequence of frames, the first plurality of pixels including sets of one or more illuminated pixels, each set of one or more illuminated pixels separated from another set of illuminated pixels by a set of non-illuminated pixels of the second plurality of pixels; and
generating, in response to an event, the object in the portion of the electronic display by illuminating pixels of the second plurality of pixels for a second sequence of frames, each set of illuminated pixels of the second plurality of pixels separated from another set of illuminated pixels within the second plurality of pixels by a set of non-illuminated pixels of the first plurality of pixels.

10. The non-transitory computer-readable medium of claim 9, the method further comprising:
generating, as a third sequence of frames, a change in shape of the object by altering a number or size of the sets of the first plurality of pixels, wherein the event is the change in shape of the object.

11. The non-transitory computer-readable medium of claim 10, wherein the object represents an eye.

12. The non-transitory computer-readable medium of claim 11, wherein the change in shape represents a blink of the eye.

13. The non-transitory computer-readable medium of claim 9, wherein the event is a temporary removal of the shape from the electronic display.

14. The non-transitory computer-readable medium of claim 9, wherein the event is a display command to swap illumination between the first and second pluralities of lines.

15. The non-transitory computer-readable medium of claim 9, wherein pixels illuminated on the electronic display are monochromatic.

16. The non-transitory computer-readable medium of claim 9, wherein the sets of illuminated pixels in the first plurality of pixels form parallel horizontal lines.

17. A system comprising:
an electronic display; and
a processor coupled to the electronic display, wherein the processor executes instructions causing the electronic display to:
generate an object in a portion of an electronic display, the object generated as a shape formed by a pattern of a first plurality pixels being illuminated for a first sequence of frames and a second plurality of pixels not being illuminated for the first sequence of frames, the first plurality of pixels including sets of one or more illuminated pixels, each set of one or more illuminated pixels separated from another set of illuminated pixels by a set of non-illuminated pixels of the second plurality of pixels; and
generating, in response to an event, the object in the portion of the electronic display by illuminating pixels of the second plurality of pixels for a second sequence of frames, each set of illuminated pixels of the second plurality of pixels separated from another set of illuminated pixels within the second plurality of pixels by a set of non-illuminated pixels of the first plurality of pixels.

18. The system of claim 17, wherein the processor executes instructions further cause the electronic display to:
generate, as a third sequence of frames, a change in shape of the object by altering a number or size of the sets of the first plurality of pixels, wherein the event is the change in shape of the object.

19. The system of claim 18, wherein the object represents an eye and the change in shape represents a blink of the eye.

20. The system of claim 17, wherein the event is a temporary removal of the shape from the electronic display.
